(19) United States
(12) Patent Application Publication
(10) Pub. No.: US 2003/0165240 A1
(43) Pub. Date: Sep. 4, 2003

(54) Decryption system for encrypted display

(76) Inventors: David F. Bantz, Chappaqua, NY (US); Thomas E. Chefalas, Somers, NY (US); Alexei A. Karve, Mohegan Lake, NY (US); Steven J. Mastrianni, Unionville, CT (US); Ajay Mohindra, Yorktown Heights, NY (US)

Correspondence Address: HARRINGTON & SMITH, LLP, 4 RESEARCH DRIVE, SHELTON, CT, 06484-6212, US

(21) Appl. No.: 10/090,699

(22) Filed: Mar. 4, 2002

(51) Int. Cl. G09C 3/00

(52) U.S. Cl. 380/54

(57) ABSTRACT

A display security system including a display device and a key FOB. The display device includes an electrical display, a file with encrypted information, a system for displaying the encrypted information on the display, and a decryption key receiver. The key FOB is adapted to transmit a description key to the decryption key receiver of the display device. The display device is adapted to display the encrypted information on the display in a decrypted form when the receiver receives the decryption key from the key FOB. The display device is adapted to not display the encrypted information on the display in a decrypted form when the receiver does not receive the decryption key from the key FOB.

### BACKGROUND OF THE INVENTION

1. Field of the Invention

The present invention relates to methods and apparatus to provide encryption and decryption of video information displayed on a computer screen.

2. Description Of The Related Art

Companies and governments have the need to send classified material using wired or wireless connections. Each type of connection has its strong points and weak points, and most can be discovered and/or hacked. There is a need to send material that may not be “top secret”, but which still might be considered confidential and harmful if released.

### SUMMARY OF THE INVENTION

In accordance with one aspect of the present invention, a display security system is provided including a display device and a key FOB. The display device includes an electrical display, a file with encrypted information, a system for displaying the encrypted information on the display, and a decryption key receiver. The key FOB is adapted to transmit a decryption key to the decryption key receiver of the display device. The display device is adapted to display the encrypted information on the display in a decrypted form when the receiver receives the decryption key from the key FOB. The display device is adapted to not display the encrypted information on the display in a decrypted form when the receiver does not receive the decryption key from the key FOB.

In accordance with another aspect of the present invention, a display system is provided comprising a frame adapted to be placed at a user's head; a display screen attached to the frame and located in front of a user's eye; a receiver connected to the frame for receiving a wireless signal having a decryption key; a system connected to the receiver for decrypting encrypted signals and displaying information contained in the encrypted signals on the display screen, the decrypting system comprising a memory and a system for temporarily storing the decryption key received by the receiver in the memory. The decrypting system requires a predetermined decryption key in the memory in order for the decryption system to decrypt the encrypted signals.

In accordance with one method of the present invention, a method of displaying encrypted information on an electronic display screen is provided comprising steps of providing a key FOB with a decryption key; transmitting the decryption key from the key FOB to a device containing the electronic display screen; applying the decryption key to the encrypted information to decrypt the encrypted information; and displaying the decrypted information on the display screen.

In accordance with another aspect of the present invention, a program storage device readable by a machine, tangibly embodied in a program of instructions executable by the machine to perform its method steps for displaying information on an electronic display screen is provided, for providing steps of determining if a predetermined decryption key has been received from a key FOB; and applying the decryption key to encrypted information and displaying the information on a display screen.

### BRIEF DESCRIPTION OF THE DRAWINGS

The foregoing aspects and other features of the present invention are explained in the following description, taken in connection with the accompanying drawings, wherein:

FIG. 1 is a block diagram of a system incorporating features of the present invention;

FIG. 2 is a block diagram of some of the components of the display device shown in FIG. 1;

FIG. 3 is a block diagram of some of the components of the key FOB shown in FIG. 1;

FIG. 4 is a diagram of an example of information displayed on a display screen of the computer shown in FIG. 1;

FIG. 5 is a schematic perspective view of an alternate embodiment of the present invention; and

FIG. 6 is a block diagram of components of the alternate embodiment shown in FIG. 5.

### DETAILED DESCRIPTION OF THE PREFERRED EMBODIMENTS

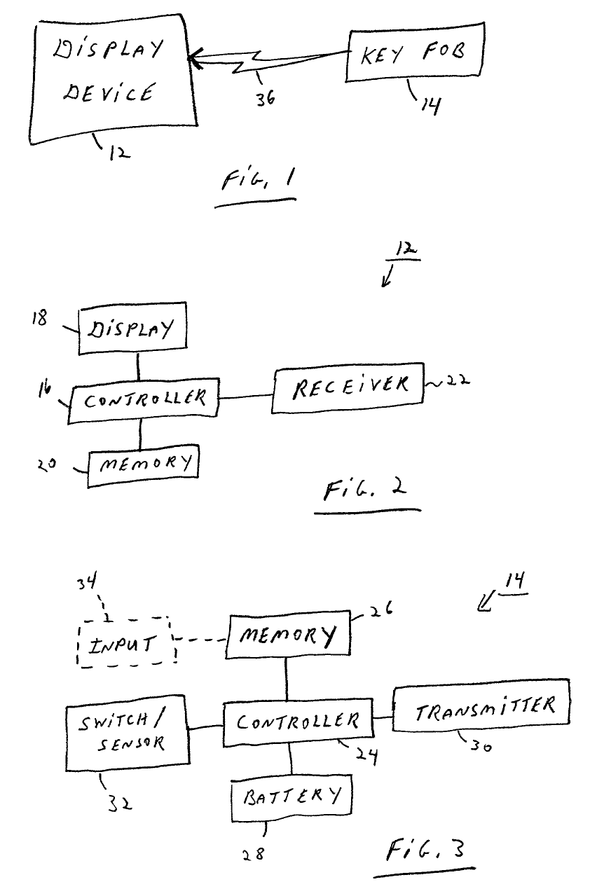

The present invention relates to methods and apparatus to provide for the encryption and decryption of certain data displayed on a computer screen or display device. Referring to FIG. 1, there is shown block diagram of a system 10 incorporating features of the present invention. Although the present invention will be described with reference to the embodiments shown in the drawings, it should be understood that the present invention can be embodied in many alternate forms of embodiments. In addition, any suitable size, shape or type of elements or materials could be used.

The system 10, in the embodiment shown, generally comprises a display device 12 and a key FOB 14. In a preferred embodiment, the display device 12 comprises a computer system having a display. However, in alternate embodiments, the display device 12 could comprise any suitable type of device having an electrical or electronic display. The computer 12 could be any suitable type of computer, such as a desktop computer, a laptop computer, or a client computer connected to a network server. Referring also to FIG. 2, the computer 12 generally comprises a controller 16, a display 18, a memory 20 and a receiver 22. Of course, the computer could comprise additional components, such as a connection to the Internet or to a network server.

The memory 20 is adapted to hold encrypted files or files which have encrypted data fields. The program documents or fields within a document can be encrypted with a digital encryption key so that an unauthorized recipient or bystander cannot easily decipher or see the material when the material is attempted to be displayed on the display 18, without first being decrypted. An encryption technique widely used today is called a Public Key Encryption or PKI. A PKI requires two keys; a public key and a private key. The public key is shared, but the private key is individually held by each recipient. The recipient must have the private key to unlock the encrypted document or document fields for viewing. In the present invention, the private key is kept in the key FOB 14 carried by the user while the public key is stored on the user's computer 12.

The receiver 22 is connected to the controller 16. In the embodiment shown, the receiver 22 is a wireless receiver, such as a radio frequency receiver. However, in alternate embodiments, any suitable type of receiver could be used, such as an optical receiver or an induction receiver.

The controller 16 is adapted to display data stored in the memory 20 (or from a network or internet connection) on the display 18. If the data to be displayed is not encrypted, then the data is displayed on the display 18 in a normal fashion. If the data to be displayed is encrypted, unless the computer 12 receives an appropriate decryption key at the receiver 22, then the controller 16 is adapted to either not display the data or otherwise display markings other than the actual data on the display. If the computer 12 receives an appropriate decryption key at the receiver 22, then the controller 16 is adapted to decrypt the encrypted information and display the decrypted information on the display 18.

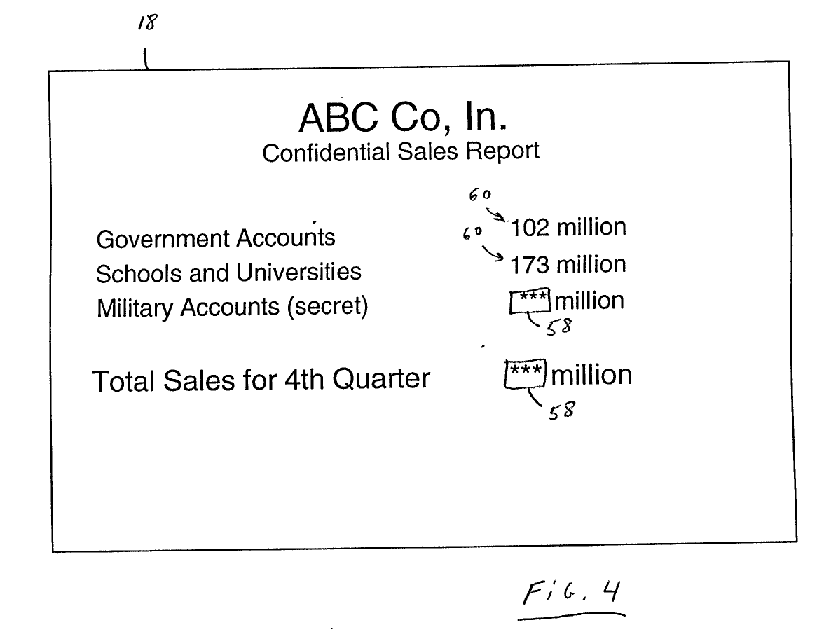

Referring also to FIG. 3, the key FOB 14 is preferably sized and shaped to be carried on or by a user, such as on a key chain, a necklace, or on an identity badge. However, any suitable type of key FOB could be provided and, the key FOB could be included in any suitable type of device adapted to be carried or worn by a user. The key FOB 14 generally comprises a controller 24, a memory 26, a battery 28, a transmitter 30 and a switch or sensor 32. In an alternate embodiment, the key FOB 14 could comprise additional or alternative components.

The memory 26 is adapted to store the decryption key therein. In a preferred embodiment, the memory 26 is programmable. However, in an alternate embodiment, the memory 26 might be fixed. In one type of embodiment, the memory 26 is adapted to store a decryption key seed. In this type of embodiment, the controller 24 can be adapted to select a decryption key from the decryption key seed. Control of the selecting process can be based upon programming in the controller 24 or, alternatively, can be controlled by an exterior controller such as the computer 12. However, in an alternate embodiment, the key FOB could be adapted to store only one decryption key at a time.

The key FOB 14 can also comprise an input device 34. The input device 34 can be adapted to input the decryption key into the memory 26 from an exterior source. In an alternate embodiment, the input device 34 might not be provided. The exterior source could comprise the computer 12, an Internet connection, a dedicated decryption key input terminal, or an e-mail transmission. The input device 34 could comprise any suitable type of signal transmission device such as an electrical connector, an optical connector, an induction connector, a radio frequency receiver, or a manual input device (such as a keypad device). The input device 34 could be removably connected to the key FOB 14. The input device 34 is shown directly connected to the memory 26. However, the input device 34 could be connected to the memory 26 by the controller 24.

The transmitter 30 preferably comprises a radio frequency transmitter. However, in alternate embodiments, any suitable type of transmitter could be provided, such as an optical transmitter; the receiver 22 being matched to the transmitter, such as an optical receiver. In another alternate embodiment, the transmitter 30 could comprise a transducer. The transmitter 30 is adapted to transmit a decryption key stored in the memory 26. In a preferred embodiment, the transmitter 30 is a low-power transmitter. The transmitter 30 is adapted to broadcast the decryption key signal 36 on a frequency which can be received by the receiver 22 in the computer 12. Because the transmitter 30 is preferably a low-power transmitter, the key FOB must be located relatively close to the receiver 22 in order for the signal transmitted from the transmitter 30 to be operably received by the receiver 22.

In the embodiment shown, the switch 32 is preferably a biometric sensor. In a preferred embodiment, the biometric sensor 32 comprises a fingerprint detection device. However, in an alternate embodiment, any suitable type of biometric sensor could be provided. In another type of alternate embodiment, the switch 32 could comprise any suitable type of locking/unlocking device, such as a keypad. In another alternate embodiment, the switch 32 might not comprise a locking/unlocking device, but instead could merely comprise a user actuated switch. An additional or alternative security system could be incorporated into the computer 12 before the computer 12 will receive the decryption key from the key FOB 14. When the switch 32 is actuated, the controller 24 is adapted to have the transmitter 30 transmit the decryption key from the memory 26. The key FOB 14 preferably periodically changes the encryption key and transmits the new key to the computer 12. The circuit inside the key FOB 14 is preferably built as a self-destructive circuit which destroys itself if anyone tries to disassemble the FOB. If security is compromised, the user can be sent a new key seed which generates a new sequence of private keys in the key FOB. The decryption key seed can be changed periodically via e-mail, the Internet, or a wired or wireless connection. In one type of embodiment, the memory 26 of the key FOB comprises means for storing a plurality of different encryption keys, and the controller 24 comprises means for periodically changing the decryption key transmitted from the transmitter 30 to the decryption key receiver.

The key FOB for the current invention is preferably activated by a biometric fingerprint reader located on the key FOB. In this preferred embodiment, the key FOB will not transmit the decryption key unless the biometric fingerprint reader reads a fingerprint which matches a predetermined fingerprint parameter. Once the biometric sensor 32 senses a predetermined biometric parameter, such as a predetermined fingerprint, the key FOB 14 will broadcast the decryption key. The display screen electronics can recognize the private digital key codes from the key FOB and employee the codes to properly display the document on the computer system. If the display is not properly unlocked by receipt of the proper decryption key, the document can be displayed as gibberish, or the encrypted fields within the document can be displayed as jumbled text or numbers.

The data preferably cannot be read from the computer system by locating the encrypted file. The data preferably can be decrypted only when viewing it. The data can preferably only be decrypted by the key in the key FOB. Thus, the document can be encrypted with a code that can only be used by a particular recipient or group of recipients. Without the correct FOB, key, and fingerprint, the document cannot be deciphered.

The encryption and decryption technology of the present invention can also be deployed in a special pair of eyeglasses, offering the user secure access to a document that others might see as gibberish. The eyeglasses can contain a small display screen for each eye, and provide for a private viewing of the data. In this case, the glasses receive the private key from the user's key FOB and use this data to decrypt the encrypted data and show it on the small display screens in the glasses.

Referring also to FIG. 4, an example of information displayed on a display screen 18 is shown. The computer 12 is adapted to display information on the display 18 which comprises fields 58 for encrypted information and fields 60 for non-encrypted information. The fields 60 for the non-encrypted information are displayed on the display 18 regardless of whether or not the receiver 22 receives the decryption key from the key FOB 14. However, the fields 58 for the encrypted information merely shows symbols or gibberish if the display device 12 has not received the decryption key from the key FOB 14.

When the computer 12 receives the decryption key from the key FOB 14, the data or information for the fields 58 is decrypted and displayed on the display 18 in the fields 58 so the information can be comprehensively viewed by the user. This is an example of a display screen which comprises encrypted and non-encrypted information. Of course, the entire display screen could be encrypted and only comprehensively viewed after the computer has received the decryption key from the key FOB 14.

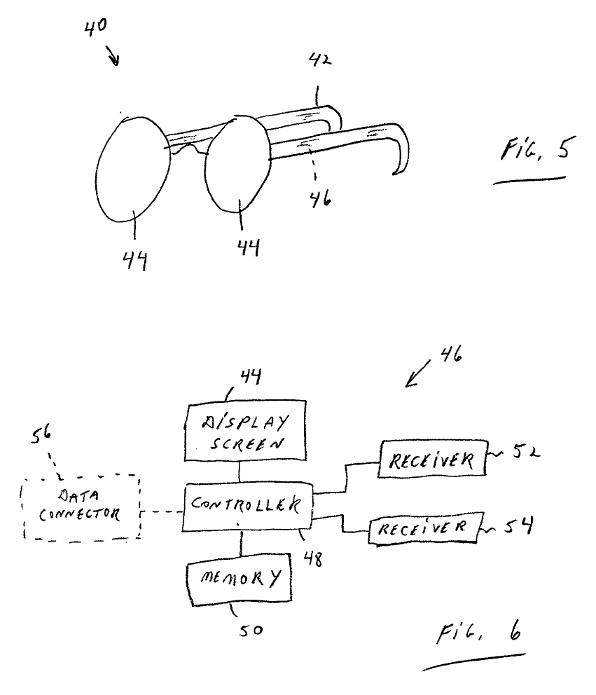

Referring also to FIGS. 5 and 6, the eyeglass type of alternate embodiment is shown. The display device or eyeglasses 40 generally comprises a frame 42, two display screens 44, and electronics 46 connected to the frame 42. The frame 42 is an eyeglass frame adapted to be located on a head of a user. When the frame 42 is located on the head of the user, the display screens 44 are located in front of the user's eyes. In an alternate embodiment, any suitable type of frame could be provided, such as a headset or helmet. In addition, the display device 40 could comprise merely one display screen or more than two display screens. The display screen 44, in the embodiment shown, could comprise an LCD display. In an alternate embodiment, the electronics 46 could comprise a projector for projecting an image onto the display screen. In this alternate embodiment, the display screen might not be an electronic or electrical display screen.

The electronics 46 generally comprises the display screens 44, a controller 48, a memory 50, a first receiver 52, and a second receiver 54. The electronics 46 could also comprise a data connector 56 for connecting the display device 40 to the computer 12 or another device (not shown) for directly transferring data by wire to the controller 48. In this alternate embodiment, the second receiver 54 might not be provided.

The first receiver 52 is generally the same as the receiver 22 shown in the embodiments of FIGS. 1-2. The first receiver 52 is adapted to receive the decryption key from the key FOB 14. The controller 48 is adapted to store the received decryption key in the memory 50.

Encrypted information can be received by the second receiver 54 or the data connector 56. The controller 48 is adapted to decrypt the encrypted information with the decryption key stored in the memory 50 and then display the decrypted information on the display screens 44.

In a preferred embodiment, the memory 50 is a volatile memory and the controller 48 is adapted to delete the decryption key stored in the memory 50 upon a predetermined event, such as after passage of a predetermined period of time after a predetermined event, or periodically. Thus, the display device 40 has a system for temporarily storing the decryption key received by the decryption key receiver 52 in the memory 50. In the event the display device 40 is lost after the memory 50 has been loaded with the decryption key, the display device 40 will become inoperative after a predetermined time or event. The display device 40 could comprise a sensor (not shown) for sensing when the frame 42 is removed from the user's head, and a signal from this head sensor could be used as the predetermined event to delete the decryption key from the memory 50.

In the present invention, the user carries the special key FOB that holds the user's private key information. When a person approaches a computer system with the present invention installed on it, the person might see a display with one or more fields obscured because information in the fields have been encrypted. Because the information is encrypted, only individuals with the proper decryption key can view the encrypted field.

When the user having the proper key FOB approaches the computer system, the user's private key data is read from the key FOB and used to decrypt the display field that is otherwise obscured using the dual key algorithm described earlier. Together, the private key and the public key provide the decryption key that unscrambles the data for viewing.

To prevent unauthorized persons from copying the data to another system and reading it there, the data is preferably encrypted in the data file. The application that creates the viewed file allows the user to identify which fields or groups of text and graphics are to be obscured. The application program can involve a function supplied to encrypt the data. Once the data is encrypted, it cannot be viewed visually or electronically without the user's private key.

For maximum privacy, the present invention can also be deployed using a set of glasses that contain small screens in the place of the lens. The display image is transmitted in an encrypted form to the secure glasses, where the secure contents are displayed on the small screens in front of each eye. The glasses will not decrypt the data unless the user has the correct decryption key in his or her key FOB.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A display security system comprising:
a display device comprising an electrical display, a file with encrypted information, a system for displaying the encrypted information on the display, and a decryption key receiver; and
a key FOB adapted to transmit a description key to the decryption key receiver of the display device,
wherein the display device is adapted to display the encrypted information on the display in a decrypted form when the receiver receives the decryption key from the key FOB, and wherein the display device is adapted to not display the encrypted information on the display in a decrypted form when the receiver does not receive the decryption key from the key FOB.

2. A display security system as in claim 1 wherein the display device comprises a computer and the electrical display comprises a computer screen.

3. A display security system as in claim 1 wherein the decryption key receiver comprises a radio frequency receiver.

4. A display security system as in claim 1 wherein the decryption key receiver comprises a wireless receiver.

5. A display security system as in claim 1 wherein the display device comprises a frame adapted to be placed on a user's head, and wherein the electrical display comprises a screen adapted to be located in front of the user's eye.

6. A display security system as in claim 1 wherein the key FOB comprises a wireless transmitter for transmitting the decryption key to the decryption key receiver.

7. A display security system as in claim 6 wherein the key FOB comprises a biometric sensor.

8. A display security system as in claim 7 wherein the biometric sensor comprises a fingerprint sensor.

9. A display security system as in claim 6 wherein the key FOB comprises means for transmitting a plurality of different encryption keys, and means for periodically changing the decryption key transmitted to the decryption key receiver.

10. A display security system as in claim 1 wherein the display device comprises a memory and a system for temporarily storing the decryption key received by the decryption key receiver in the memory.

11. A display security system as in claim 10 wherein the display device comprises means for deleting the decryption key stored in the memory upon a predetermined event.

12. A display security system as in claim 11 wherein the means for deleting the decryption key stored in the memory can delete the decryption key periodically or after passage of a predetermined period of time after a predetermined event.

13. A display system comprising:
a frame adapted to be placed at a user's head;
a display screen attached to the frame and located in front of a user's eye;
a first receiver connected to the frame for receiving a wireless signal having a decryption key;
a system connected to the receiver for decrypting encrypted signals and displaying information contained in the encrypted signals on the display screen, the decrypting system comprising a memory and a system for temporarily storing the decryption key received by the receiver in the memory,
wherein the decrypting system requires a predetermined decryption key in the memory in order for the decryption system to decrypt the encrypted signals.

14. A display system as in claim 13 wherein the frame comprises an eyeglass frame.

15. A display system as in claim 13 wherein the receiver is a wireless radio frequency receiver.

16. A display system as in claim 13 wherein the memory comprises a volatile memory.

17. A display system as in claim 13 further comprising a second receiver connected to the frame for receiving the encrypted signals.

18. A display system as in claim 17 wherein the second receiver comprises a wireless radio frequency receiver.

19. A display system as in claim 13 wherein the decrypting system comprises means for deleting the decryption key in the memory upon a predetermined event.

20. A display system as in claim 13 wherein the decrypting system comprises means for deleting the decryption key in the memory periodically.

21. A method of displaying encrypted information on an electronic display screen comprising steps of:
providing a key FOB with a decryption key;
transmitting the decryption key from the key FOB to a device containing the electronic display screen;
applying the decryption key to the encrypted information to decrypt the encrypted information; and
displaying the decrypted information on the display screen.

22. A method as in claim 21 wherein the step of transmitting the decryption key from the key FOB comprises transmitting the decryption key by a wireless transmitter in the key FOB.

23. A method as in claim 21 further comprising providing the key FOB with a biometric sensor, and wherein the step of transmitting the decryption key from the key FOB occurs after the biometric sensor senses a predetermined biometric parameter of the user.

24. A method as in claim 23 wherein the biometric sensor comprises a fingerprint sensor, and the fingerprint sensor senses a fingerprint of the user.

25. A program storage device readable by a machine, tangibly embodied in a program of instructions executable by the machine to perform its method steps, for displaying information on an electronic display screen comprising steps of:
determining if a predetermined decryption key has been received from a key FOB; and
applying the decryption key to encrypted information and displaying the information on a display screen.
